(19) United States
(12) Patent Application Publication
(10) Pub. No.: US 2025/0276237 A1
(43) Pub. Date: Sep. 4, 2025

(54) CLAW DEVICE FOR CRANE MACHINE, GRIPPER FOR CRANE MACHINE, AND CRANE MACHINE

(71) Applicant: Canqi Yan, Shantou City (CN)

(72) Inventor: Canqi Yan, Shantou City (CN)

(21) Appl. No.: 19/088,021

(22) Filed: Mar. 24, 2025

Related U.S. Application Data
(63) Continuation-in-part of application No. 18/812,296, filed on Aug. 22, 2024.

(30) Foreign Application Priority Data
Nov. 28, 2023 (CN) 202323234437.5

(51) Int. Cl. A63F 9/30; G07F 17/32

(52) U.S. Cl. CPC A63F 9/30; G07F 17/3297

(57) ABSTRACT

A claw device for a crane machine, a gripper for a crane machine, and a crane machine. The gripper includes an adjustment assembly, an actuating assembly, and a limiting column. The adjustment assembly includes a fixed disk and connecting rods. The actuating assembly includes a pivot plate and clamping rods. Each clamping rod includes a connecting segment, a fixed segment, and a holding segment. Each connecting rod is connected to the fixed disk and the connecting segment. The limiting column defines a limiting hole. A lower part of the fixing hole corresponds to the limiting column, and an aperture of the fixing hole is greater than an aperture of the limiting hole; or another the limiting column is arranged corresponding to a lower side of the second adjustment hole, and an aperture of the second adjustment hole is greater than an aperture of the limiting hole.

### CROSS-REFERENCE TO RELATED APPLICATIONS

The present application is a continuation-in-part of U.S. application Ser. No. 18/812,296, which is filed on Aug. 22, 2024, the entire contents of which are hereby incorporated by reference in its entirety.

### TECHNICAL FIELD

The present disclosure relates to the technical field of gaming equipment, and more specifically to a claw device for a crane machine, a gripper for a crane machine, and a crane machine.

### BACKGROUND

In a capture game of catching or trapping a target, the game player needs to use a gripping claw to capture the game target. For different types of players, the claws should be designed to stimulate the interest of the players. In order to increase the challenge of the games, to stimulate the enthusiasm of adult gamers, the design of the claws should be aimed to achieve a relatively low success rate of the capture. Since child game players' operating ability is limited, in order to ensure that children can exercise hand and foot coordination and enjoy the fun in the games, the design of the claws should be aimed to achieve a relatively high success rate of the capture.

However, the existing claw design only meets the needs of adult gamers, and seldom considers the needs of child gamers. When the child game players use the claws designed for adult game players, the low success rate of the capture does not allow the child game players to obtain positive feedback in the games, which strikes the enthusiasm of the child game players to participate in the capture games. With the development of the crane machine market for children, the above problem is required to be mitigated or even solved.

### SUMMARY OF THE DISCLOSURE

In view of the above problems, the present disclosure proposes a claw device for a crane machine, aiming to solve the technical problem that conventional claw devices are prone to tilting, and the low success rate of grabbing affects the sense of game experience of children gamers.

A claw device for a crane machine, including an adjustment assembly and an actuating assembly movably connected to the adjustment assembly; wherein the adjustment assembly includes a fixed disk and at least two connecting rods spaced apart along an outer peripheral edge of the fixed disk; the actuating assembly includes a pivot plate disposed below the fixed disk and at least two clamping rods spaced apart along an outer peripheral edge of the pivot plate; a viewing window is formed between each adjacent two of the at least two clamping rods; each clamping rod includes a connecting segment, a fixed segment, and a holding segment that are sequentially connected; the connecting segment is movably connected to the pivot plate; the fixed segment includes a first clamping surface toward a center axis of the pivot plate; the holding segment extends toward the center axis of the pivot plate from a lower end of the fixed segment; the holding segment includes a first holding surface toward the center axis of the pivot plate; the first holding surface is connected to the first clamping surface, and the first holding surface and the first clamping surface are arranged at an angle; an end of each connecting rod is movably connected to the fixed disk, and the other end of the connecting rod is movably connected to the connecting segment of a corresponding clamping rod; wherein the fixed disk defines a first adjustment hole and a fixing hole, and the first adjustment hole and the fixing hole both pass through the fixed disk in an up-down direction; the pivot plate defines a second adjustment hole, and the second adjustment hole passes through the pivot plate in the up-down direction; a gravity center of the fixed disk is located in the first adjustment hole, and a projection of the gravity center of the fixed disk falls within the second adjustment hole; wherein the claw device further includes a limiting column; the limiting column defines a limiting hole, and the limiting hole runs through the limiting column in the up-down direction; the limiting hole is arranged with a mounting notch, and a width of the mounting notch is less than an inner diameter of the limiting hole; wherein, a lower part of the fixing hole corresponds to the limiting column, and an aperture of the fixing hole is greater than an aperture of the limiting hole; or another the limiting column is arranged corresponding to a lower side of the second adjustment hole, and an aperture of the second adjustment hole is greater than an aperture of the limiting hole.

In some embodiments, a lower surface of the fixed disk defines a first accommodation groove; a lower end of the fixing hole runs through the first accommodation groove, and the limiting column is arranged in the first accommodation groove; a sidewall surface of the first accommodation groove abuts against an outer peripheral surface of the limiting column and closes or seals the mounting notch of the limiting column.

In some embodiments, a lower surface of the pivot plate defines a second accommodation groove; a lower end of the second adjustment hole runs through the second accommodation groove, and the other limiting column is arranged in the second accommodation groove; a sidewall surface of the second accommodation groove abuts against an outer peripheral surface of the other limiting column and closes or seals the mounting notch of the other limiting column.

A gripper for a crane machine, including: an adjustment assembly, including a fixed disk and at least two connecting rods arranged at intervals along an outer periphery of the fixed disk; wherein the fixed disk defines a first adjustment hole and a fixing hole, and the first adjustment hole and the fixing hole both extend along an up-down direction and through the fixed disk; the first adjustment hole and the fixing hole are configured for a bead chain to move up and down; an actuating assembly, movably connected to the adjustment assembly; wherein the actuating assembly includes a pivot plate arranged below the fixed disk and at least two clamping rods arranged at intervals along an outer periphery of the pivot plate; a middle portion of the pivot plate defines a second adjustment hole extending along the up-down direction and through the pivot plate, and the second adjustment hole is configured for the bead chain to move up and down; an end of each connecting rod is movably connected to the fixed disk, and another end of the connecting rod is movably connected to a corresponding clamping rod; an end of each clamping rod is movably connected to the pivot plate; tail ends of each adjacent two of the at least two clamping rods are capable of moving together and of moving separated to achieve an opening-closing function of the gripper; and a limiting sleeve; wherein the limiting sleeve defines an opening on an end along an axial direction of the limiting sleeve and is arranged with an end wall at an opposite end; the end wall is arranged with a first channel, and a side wall of the limiting sleeve is arranged with a second channel communicating with the first channel; wherein the limiting sleeve is arranged below the fixing hole, a diameter of the fixing hole being greater than a maximum width of the first channel of the limiting sleeve; or, another the limiting sleeve is arranged below the second adjustment hole, a diameter of the second adjustment hole being greater than a maximum width of the first channel of the other limiting sleeve.

In some embodiments, an inner wall of the first channel is arranged with an anti-disconnecting member protruding from a middle position along an extension direction of the first channel, to prevent the bead chain from disengaging from the limiting sleeve.

In some embodiments, the anti-disconnecting member comprises two limiting protrusions arranged opposite each other, and the two limiting protrusions are arranged at intervals to define a slit; the two limiting protrusions and an inner wall surface of the first channel enclose to define a mounting hole adapted to the bead chain; a width of the slit is less than a diameter of the mounting hole, and the slit is connected to the mounting hole and the second channel.

In some embodiments, an inner surface of the end wall defines a recess, and the first channel is disposed in the recess.

In some embodiments, an outer side wall of the limiting sleeve is arranged with a first snap-fit portion, and the fixed disk or the pivot plate is arranged with a second snap-fit portion that is adapted to the first snap-fit portion; one of the first snap-fit portion and the second snap-fit portion is a convex portion, and the other of the first snap-fit portion and the second snap-fit portion is a convex portion is a groove.

In some embodiments, the limiting sleeve is arranged with the second channel and an avoidance notch on opposite sides along the axial direction; the outer side wall of the limiting sleeve includes a guide bevel, and the avoidance notch is disposed on the guide bevel; the first snap-fit portion includes at least two protrusions, and the at least two protrusions are disposed on opposite sides of the second channel or the avoidance notch.

In some embodiments, a width of the second channel is less than a width of the first channel.

In some embodiments, the gripper further includes a pivot structure including a fixing post and a deformable part connected to each other, and the fixing post and the deformable part are arranged along an axial direction of the fixing post; wherein the fixing post and the deformable part pass through a corresponding connecting rod and the fixed disk, and the deformable part as well as the corresponding connecting rod or the fixed disk are limited in the axial direction of the fixing post; or, the fixing post and the deformable part pass through a corresponding connecting rod and a corresponding clamping rod, and the deformable part as well as the corresponding connecting rod or the corresponding clamping rod are limited in the axial direction of the fixing post; or, the fixing post and the deformable part pass through a corresponding clamping rod and the pivot plate, and the deformable part as well as the corresponding clamping rod or the pivot plate are limited in the axial direction of the fixing post.

In some embodiments, the pivot structure further includes two opposing bosses, and a pivot tab sandwiched between the two bosses; the two bosses and the pivot tab each define a through hole; the deformable part includes at least two elastic catches arranged on an end of the fixing post, and the at least two elastic catches are arranged along the axial direction of the fixing post; the fixing post is inserted into the through hole, and the at least two elastic catches are engaged with the two bosses in the axial direction of the fixing post; wherein one of a corresponding connecting rod and the fixed disk is arranged with the two bosses arranged opposite each other, and the other of the corresponding connecting rod and the fixed disk is arranged with the pivot tab; or, one of a corresponding connecting rod and the clamping rod is arranged with the two bosses, and the other of the corresponding connecting rod and the clamping rod is arranged with the pivot tab; or, one of a corresponding clamping rod and the pivot plate is arranged with the two bosses, and the other of the corresponding clamping rod and the pivot plate is arranged with the pivot tab.

In some embodiments, an end of the fixing post away from the at least two elastic catches extends beyond a surface of the two bosses in the axial direction of the fixing post.

In some embodiments, the fixing post has an internal cavity.

In some embodiments, each connecting rod and a corresponding clamping rod are rotatably connected; an end of the connecting rod close to the corresponding clamping rod is arranged with a first abutment protrusion, and a second abutment protrusion adapted to the first abutment protrusion is arranged on the corresponding clamping rod; the second abutment protrusion is arranged relative to the first abutment protrusion close to a central axis of the pivot plate; the second abutment protrusion is located in a movement path of the first abutment protrusion, and the first abutment protrusion is caused to be rotatable to abut against the second abutment protrusion.

In some embodiments, the gripper further includes a pallet that is removably mounted on the tail end of each clamping rod; the pallet includes a third clamping surface disposed towards a central axis of the pivot plate and a third holding surface disposed opposite the third clamping surface; the third holding surface is attached on a plane of the clamping rod that is close to the central axis of the pivot plate; the pallet further includes an enclosure that is arranged around an edge of the third clamping surface.

In some embodiments, the gripper further includes a pallet that is removably mounted on the tail end of each clamping rod; the pallet includes a third clamping surface disposed towards a central axis of the pivot plate and a third holding surface disposed opposite the third clamping surface; the third holding surface is attached on a plane of the clamping rod that is close to the central axis of the pivot plate; the third holding surface is arranged with a limiting catch and an assembly groove; the limiting catch and the assembly groove are distributed along an extension direction of the clamping rod; a rod body of the clamping rod is engaged with the limiting catch, and the tail end of the clamping rod is inserted into the assembly groove.

In some embodiments, the gripper further includes a pallet that is removably mounted on the tail end of each clamping rod; an end of the pallet includes a second tooth that is protruding towards a central axis of the pivot plate.

In some embodiments, a through hole is defined on a middle portion of each clamping rod, and an aperture of the through hole extends along an extension direction of the clamping rod.

A crane machine, including a bead chain, a driving device, and the gripper as above; wherein the bead chain connects the gripper and the driving device; the driving device is configured to cause the fixed disk and the pivot plate of the gripper to move closer to or away from each other by driving the bead chain; in a case where the fixed disk and the pivot plate of the gripper move closer to each other, the at least two clamping rods of the gripper move closer to each other; in a case where the fixed disk and the pivot plate of the gripper move away from each other, the at least two clamping rods of the gripper move away from each other.

In summary, the present disclosure discloses a claw device for a crane machine. The claw device may limit the range of movement of the fixing rope or adjustment rope by making the aperture of the limiting hole in the limiting column less than the aperture of the fixing hole or the second adjustment hole, so as to avoid the success rate of grabbing falling due to the excessive tilting of the fixing rope or adjustment rope. In addition, the width of the mounting notch of the claw device is less than the diameter of the limiting hole, such that the fixing rope or adjustment rope can move within the limiting hole but cannot easily detach from the limiting column, thereby preventing the fixing rope and adjustment rope from detaching from the fixed disk or pivot plate when they are violently shaken to untangle the entanglement.

The present disclosure further discloses a gripper for a crane machine. The gripper may, through the setting of the limiting sleeve, solve the problem of the gripper tilting easily and the success rate of grabbing objects being not high due to the excessively large diameter of the fixing hole or the second adjustment hole.

### BRIEF DESCRIPTION OF THE DRAWINGS

To illustrate the technical solutions of the embodiments of the present disclosure more clearly, the accompanying drawings of the embodiments will be briefly described below, and it will be apparent that the accompanying drawings in the following description relate only to some embodiments of the present disclosure and other drawings may be obtained from these drawings by those skilled in the art without creative labor.

FIG. 1 is a structural schematic view of a claw device for a crane machine according to some embodiments of the present disclosure.

FIG. 2 is a structural schematic view of a claw device for a crane machine according to other embodiments of the present disclosure.

FIG. 3 is an exploded structural schematic view of the claw device in FIG. 2.

FIG. 4 is a structural schematic view of a claw device for a crane machine according to further other embodiments of the present disclosure.

FIG. 5 is a structural schematic view of a claw device for a crane machine according to still other embodiments of the present disclosure.

FIG. 6 is a structural schematic view of a claw device for a crane machine according to still other embodiments of the present disclosure.

FIG. 7A illustrates a structural schematic view of a limiting column in FIG. 6 at one viewing angel. FIG. 7B illustrates a structural schematic view of the limiting column in FIG. 6 at another viewing angle. FIG. 7C illustrates a structural schematic view of the limiting column in FIG. 6 at another viewing angle.

FIG. 8A illustrates a structural schematic view of a fixed disk in FIG. 6 at one viewing angel. FIG. 8B illustrates a structural schematic view of the fixed disk in FIG. 6 at another viewing angle.

FIG. 9 is a structural schematic view of a fixed disk according to some embodiments of the present disclosure.

FIG. 10 is a structural schematic view of a gripper for a crane machine according to some embodiments of the present disclosure at a first viewing angle.

FIG. 11 is a structural schematic view of the gripper for the crane machine in FIG. 10 at a second viewing angle.

FIG. 12 is a structural schematic view of the gripper for the crane machine in FIG. 10 at a third viewing angle, with a pallet omitted.

FIG. 13 is a partial cross-sectional schematic view of a gripper for a crane machine according to some embodiments of the present disclosure at a viewing angle.

FIG. 14 is a partial cross-sectional schematic view of a gripper for a crane machine according to some embodiments of the present disclosure at another viewing angle.

FIG. 15 is a structural schematic view of a fixing member according to some embodiments of the present disclosure.

FIG. 16 is a structural schematic view of a limiting sleeve according to some embodiments of the present disclosure at a viewing angle.

FIG. 17 is a structural schematic view of a limiting sleeve according to some embodiments of the present disclosure at another viewing angle.

| No. | Name | No. | Name | No. | Name |
|---|---|---|---|---|---|
| 100 | Claw device for | 13 | First tab | 224 | First groove |
| | crane machine | | | | |
| 10 | Adjustment | 14 | First | 23 | Viewing window |
| | assembly | | rotating shaft | | |
| 11 | Fixed disk | 20 | Actuating | 24 | Second tab |
| | | | assembly | | |
| 1111 | First adjustment | 21 | Pivot plate | 25 | Second |
| | hole | | | | rotating shaft |
| 112 | Edge region | 211 | Second | 30 | Pallet |
| | | | adjustment hole | | |
| 1121 | Fixing hole | 22 | Clamping rod | 31 | Clamping portion |
| 113 | Connecting | 221 | Connecting | 311 | Second clamping |
| | channel | | segment | | surface |
| 12 | Connecting rod | 222 | Fixed segment | 32 | Holding portion |
| 121 | First | 2221 | First clamping | 321 | Second holding |
| | shaft hole | | surface | | surface |
| 122 | First notch | 223 | Holding segment | 33 | Mounting seat |
| 123 | Second groove | 2231 | First | 331 | Mounting groove |
| | | | holding surface | | |
| 40 | Rope | 124 | Second shaft hole | 125 | Second notch |
| 50 | Limiting column | 51 | Limiting hole | 52 | Mounting notch |
| 61 | First | 62 | Second | 63 | Fixing rope |
| | accommodation | | accommodation | | |
| | groove | | groove | | |
| 64 | Adjustment rope | 65 | First | 66 | Second |
| | | | limiting ball | | limiting ball |
| 67 | Third | | | | |
| | accommodation | | | | |
| | groove | | | | |

The realization of the purpose, functional features, and advantages of the present disclosure will be further described in conjunction with the embodiments and with reference to the accompanying drawings.

### DETAILED DESCRIPTION

The technical solutions in the embodiments of the present disclosure will be described clearly and completely in the following in conjunction with the accompanying drawings in the embodiments of the present disclosure, and it is obvious that the described embodiments are only a part of the embodiments of the present disclosure and not all of the embodiments. Based on the embodiments in the present disclosure, all other embodiments obtained by those skilled in the art without creative labor fall within the scope of the present disclosure. In addition, the technical solutions between various embodiments can be combined with each other, but it must be based on the fact that those skilled in the art is able to realize it. When the combination of the technical solutions appears to be contradictory or unattainable, it should be considered that the combination of such technical solutions does not exist, and is not included in the scope claimed by the present disclosure.

It should be noted that when the embodiments of the present disclosure involve directional indications (such as up, down, left, right, forward, back . . . ), the directional indications are only intended to explain a relative positional relationship, a movement, etc. between the various components in a particular attitude. When the particular attitude changes, the directional indications are also changed accordingly.

In addition, when the embodiments of the present disclosure contain descriptions involving “first”, “second”, etc., the descriptions of “first”, “second”, etc. are intended only for descriptive purposes, and are not to be construed as indicating or implying their relative importance or implicitly specifying the number of the indicated technical features. That is, a feature defined as “first” or “second” may include at least one such feature either explicitly or implicitly. In addition, the meaning of “and/or” in the whole text is to include three concurrent solutions. For example, “A and/or B” includes an A solution, a B solution, and a solution in which A and B are satisfied at the same time.

The present disclosure proposes a claw device for a crane machine.

The claw device 100 includes an adjustment assembly 10 and an actuating assembly 20 movably connected to the adjustment assembly 10; the adjustment assembly 10 includes a fixed disk 11 and at least two connecting rods 12 spaced apart along an outer peripheral edge of the fixed disk 11; the actuating assembly 20 includes a pivot plate 21 disposed below the fixed disk 11 and at least two clamping rods 22 spaced apart along an outer peripheral edge of the pivot plate 21; a viewing window 23 is formed between adjacent two clamping rods 22; each clamping rod 22 includes a connecting segment 221, a fixed segment 222, and a holding segment 223 that are sequentially connected; the connecting segment 221 is movably connected to the pivot plate 21; the fixed segment 222 includes a first clamping surface 2221 toward a center axis of the pivot plate 21; the holding segment 223 extends toward the center axis of the pivot plate 21 from a lower end of the fixed segment 222; the holding segment 223 includes a first holding surface 2231 toward the center axis of the pivot plate 21; the first holding surface 2231 is connected to the first clamping surface 2221, and the first holding surface 2231 and the first clamping surface 2221 are arranged at an angle; an end of the connecting rod 12 is movably connected to the fixed disk 11, and the other end of the connecting rod 12 is movably connected to the connecting segment 221.

The claw device 100 refers to a component of the crane machine that can simulate an opening or closing action of a hand to grasp a subject (e.g., doll). The adjustment assembly 10 refers to a component of the claw device 100 that can drive other components to move to accomplish the opening or closing action. The actuating assembly 20 refers to a component of the claw device 100 that directly accomplishes the opening or closing action. The adjustment assembly 10 includes a fixed disk 11 and at least two connecting rods 12 spaced along an outer peripheral edge of the fixed disk 11; the number of the connecting rods 12 may be two, three, four, etc. The actuating assembly 20 includes a pivot plate 21 disposed below the fixed disk 11 and at least two clamping rods 22 spaced along an outer peripheral edge of the pivot plate 21. The number of the clamping rods 22 is set corresponding to the number of the connecting rods 12; the number of the clamping rods 22 may be two, three, four, etc.

A viewing window 23 is formed between each adjacent two clamping rods 22. Compared to a clamping member shaped like a bucket, the rod-shaped clamping member in the embodiments may facilitate the game player to observe the positional relationship between a target subject and a clamping portion 31, and thus assist the game player in adjusting the game strategy to improve the grasping success rate.

The clamping rod 22 includes a connecting segment 221, a fixed segment 222, and a holding segment 223 that are sequentially connected. The connecting segment 221 is movably connected to the pivot plate 21. An end of the connecting segment 221 is movably connected to the pivot plate 21, and the adjustment assembly 10 is configured to drive the connecting segment 221 to move by adjusting a height of the pivot plate 21; the other end of the connecting segment 221 is connected to the fixed segment 222. The fixed segment 222 includes a first clamping surface 2221 toward a center axis of the pivot plate 21; the holding segment 223 extends from a lower end of the fixed segment 222 toward the center axis of the pivot plate 21; the holding segment 223 includes a first holding surface 2231 toward the center axis of the pivot plate 21; the first holding surface 2231 is connected to the first clamping surface 2221, and the first holding surface 2231 and the first clamping surface 2221 are arranged at an angle. In some embodiments, the first holding surface 2231 is flat. In this way, when the target subject is being grasped, the first holding surface 2231 can uniformly provide a supporting force, such that the target subject will not fall down due to an unbalanced force during the movement of the claw device.

The angle between the first holding surface 2231 and the first clamping surface 2221 is greater than or equal to 90 degrees and less than or equal to 120 degrees. If the angle between the first holding surface 2231 and the first clamping surface 2221 is less than 90 degrees, the first holding surface 2231 can provide a limited support force to the target subject, making it difficult to secure the target subject in the claw device. If the angle between the first holding surface 2231 and the first clamping surface 2221 is greater than 120 degrees, the target subject is very likely to fall when the claw device 100 is moving. In the embodiments, however, the angle between the first holding surface 2231 and the first clamping surface 2221 is greater than or equal to 90 degrees and less than or equal to 120 degrees. When grasping the target subject, this angle may make the target subject be fixed in the claw device to prevent the claw device being failed in grasping; when the claw device is moving, this angle may ensure that the first holding surface 2231 can provide sufficient upward support force to prevent the target subject from falling.

An end of the connecting rod 12 is movably connected to the fixed disk 11, and the other end of the connecting rod 12 is movably connected to the connecting segment 221. The claw device 100 can cause the connecting rod 12 to move relative to the fixed disk 11 and the pivot plate 21 by adjusting a height difference between the fixed disk 11 and the pivot plate 21. Since the connecting rod 12 is movably connected to the connecting segment 221, the connecting rod 12 can drive the connecting segment 221 to move, which in turn causes the multiple clamping members to separate from each other or come close to each other, thereby accomplishing the simulated opening or closing action of the hand.

The present disclosure discloses a claw device 100 for a crane machine, including an adjustment assembly 10 and an actuating assembly 20; the adjustment assembly 10 includes a fixed disk 11 and connecting rods 12; the actuating assembly includes a pivot plate 21 and clamping rods 22; an viewing window 23 is formed between each adjacent two of the clamping rods 22; each clamping rod 22 includes a connecting segment 221, a fixed segment 222, and a holding segment 223 that are sequentially connected, where the connecting segment 221 is movably connected to the pivot plate 21, and the holding segment 223 extends towards a center axis of the pivot plate; a first holding surface 2231 of the holding segment 223 is connected to a first clamping surface 2221 of the fixed segment 222, and the first holding surface 2231 and the first clamping surface 2221 are arranged at an angle; an end of the connecting rod 12 is connected to the fixed disk 11, and the other end of the connecting rod 12 is connected to the connecting segment 221. In the present disclosure, the first clamping surface 2221 and the first holding surface 2231 are arranged at an angle to enable the target subject to be firmly grasped by the claw device without easily falling, and the viewing window 23 formed between adjacent clamping rods 22 facilitates the game player to observe the positional relationship between the target subject and the clamping rods 22 to adjust the game strategy, thereby improving the grasping success rate of the claw device.

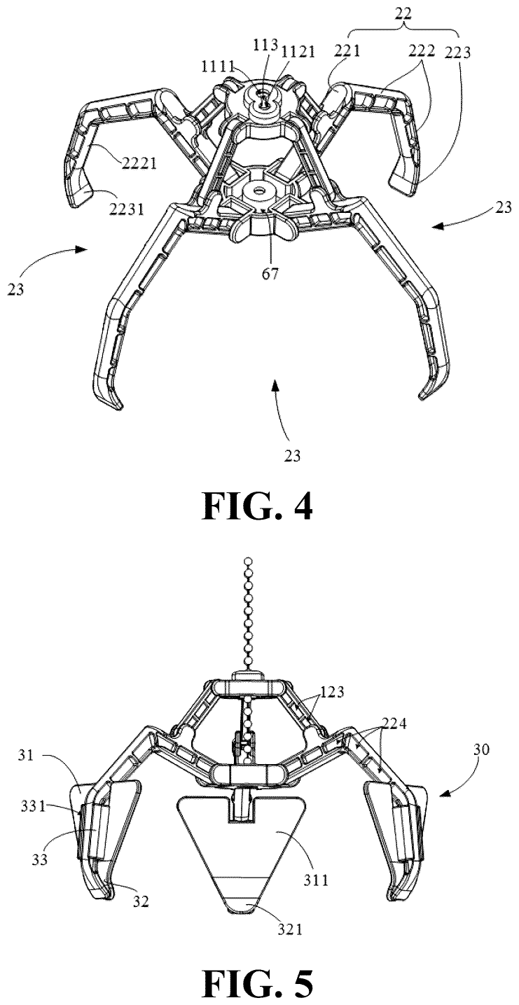

Further, referring to FIG. 4, a width direction of the first holding surface 2231 intersects with an extension direction of the holding segment 223; a width of the first holding surface 2231 gradually increases along the extension direction of the holding segment 223 away from the fixed segment 222.

In the embodiments, the gradual increase in the width of the first holding surface 2231 along the extension direction of the holding segment 223 may increase the contact area between the first holding surface 2231 and the target subject, such that the target subject can be steadily grasped by the claw device. In other words, the increase in the contact area between the first holding surface 2231 and the target subject may facilitate the claw device to fix the target subject and further prevent the target subject from falling during the movement of the claw device.

Further, referring to FIG. 5, the claw device 100 includes a pallet 30 detachably arranged on the fixed segment 222. The pallet 30 includes a clamping portion 31 and a holding portion 32 connected to a lower side of the clamping portion 31; the clamping portion 31 includes a second clamping surface 311 extending along a width direction of the first clamping surface 2221; a width of the second clamping surface 311 is greater than a width of the first clamping surface 2221. Referring to FIGS. 4 and 5, the pallet 30 further includes the holding portion 32 connected to the lower side of the clamping portion 31; the holding portion 32 includes a second holding surface 321 extending along a width direction of the first holding surface 2231; a width of the second holding surface 321 is greater than a width of the first holding surface 2231; a flat surface on the pallet that is back away from the second holding surface 321 is attached to the first holding surface 2231.

In the embodiments, the claw device 100 includes the pallet 30 detachably arranged on the fixed segment 222. The pallet 30 may be in a variety of shapes, such as triangle, circle, rectangle, and other regular and irregular shapes. The pallet 30 may be disposed both on an inner side and/or an outer side of the fixed segment 222. The pallet 30 may increase the contact area with the target subject, enabling the claw device to securely clamp the target subject. The pallet 30 is detachably arranged on the holding segment 223, which may facilitate parents to adjust the difficulty of the game by mounting or removing the pallet 30, such that the crane machine game can be adapted to child gamers of different ages.

The pallet 30 includes a clamping portion 31. The clamping portion 31 includes a second clamping surface 311 extending in a width direction of the first clamping surface 2221; the width of the second clamping surface 311 is greater than the width of the first clamping surface 2221. Compared to the first holding surface 2221, the second holding surface 311 increases the contact area with the target subject, thereby providing sufficient support and friction at the position of the fixed segment 222, such that the clamping rod 22 can clamp the target subject more securely.

Compared to the first holding surface 2231, the second holding surface 321 increases the contact area with the target subject, thereby providing more upward support force at the position of the holding segment 223, such that that the target subject may not be dislodged from the claw device easily.

A flat surface on the pallet that is back away from the second holding surface 321 is attached to the first holding surface 2231. In other words, the pallet 30 is arranged on the inner side of the fixed segment 222, rather than on the outer side of the fixed segment 222. When the pallet 30 is arranged on the outer side of the fixed segment 222, the fixed segment 222 is sandwiched between the target subject and the pallet 30. When the pallet 30 is arranged on the inner side of the fixed segment 222, the target subject is in direct contact with the pallet 30, i.e., there is no barrier between the target subject and the pallet 30. When the target subject is filled with cotton, the grasping success rate of the claw device is not greatly affected by whether the pallet 30 is arranged on the inner side or the outer side of the fixed segment 222. Currently, in order to increase the fun of the crane machine game, the target subject may further be a doll made of plastic or a doll arranged in a spherical mold, and the game player can directly grasp the spherical mold. When the pallet 30 is arranged on the outer side of the fixed segment 222, the fixed segment 222 clamped between the target subject and the pallet 30 may easily cause the doll to fall off, thereby reducing the success rate of grasping by the claw device. In the embodiments, the pallet 30 is arranged on the inner side of the fixed segment 222, and the pallet 30 can be in full contact with the target subject without obstruction, which may improve the grasping success rate of the claw device.

Further, referring to FIG. 5, a partial region of the pallet 30 is raised to form a mounting seat 33, and the mounting seat 33 defines a mounting groove 331; an inner diameter of the mounting groove 331 is gradually decreased along a length direction of the clamping rod 22, and the minimum inner diameter of the mounting groove 331 is less than or equal to an outer diameter of the fixed segment 222; the fixed segment 222 is detachably arranged in the mounting groove 331.

In the embodiments, a partial region of the pallet 30 is raised to form a mounting seat 33, and the mounting seat 33 defines a mounting groove 331. In some embodiments, a central region of the pallet 30 is raised to form the mounting seat 33. Compared with other regions of the pallet 30 being raised to form the mounting seat 33, the central region of the pallet 30 being raised to form the mounting seat 33 may enable the pallet 30 to uniformly withstand the tension from the target subject, preventing the pallet 30 from rotating around the fixed segment 222 due to uneven force on the pallet 30. In addition, the central region of the pallet 30 being raised to form the mounting seat 33 makes the grasping stability of the claw device better, thereby improving the grasping success rate of the claw device, which is more suitable for a child gamer.

The inner diameter of the mounting groove 331 is gradually reduced along the length direction of the clamping rod 22, and the minimum inner diameter of the mounting groove 331 is less than or equal to the outer diameter of the fixed segment 222, which may facilitate the mounting of the fixed segment 222 to the mounting groove 331 from a position where the inner diameter of the mounting groove 331 is greater, and further enable the mounting groove 331 to have an interference fit with the fixed segment 222 at a position where the inner diameter of the mounting groove 331 is the least. Whether the fixed segment 222 can be stably assembled with the mounting groove 331 has a significant impact on the grasping success rate of the claw device. In the embodiments, the tapering of the inner diameter of the mounting groove 331 allows the mounting groove 331 and the fixed segment 222 to be securely assembled, which further improves the grasping success rate of the claw device.

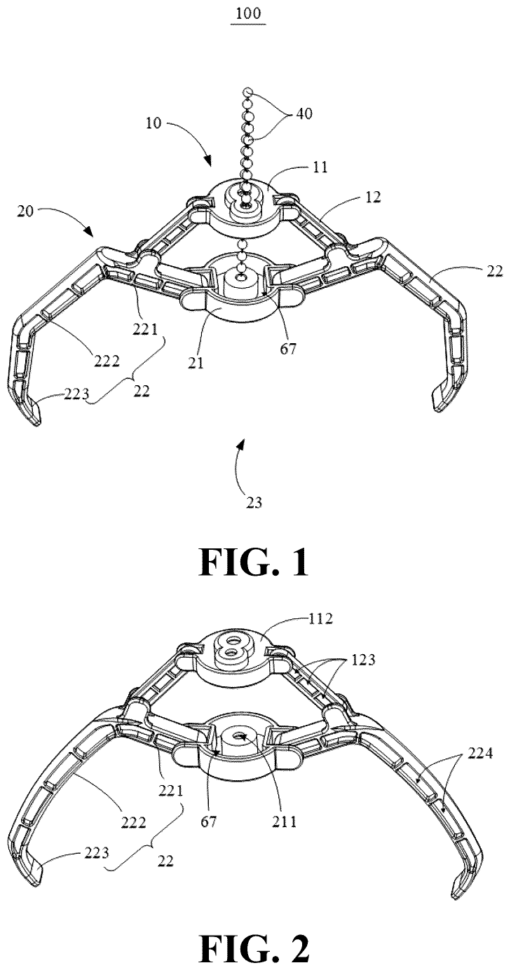

In some embodiments, referring to FIGS. 1, 2, 4, 6, 8, and 9, the fixed disk 11 defines a first adjustment hole 1111 and a fixing hole 1121, and the first adjustment hole 1111 and the fixing hole 1121 both pass through the fixed disk 11 in an up-down direction; the pivot plate 21 defines a second adjustment hole 211, and the second adjustment hole 211 passes through the pivot plate 21 in the up-down direction; a gravity center of the fixed disk 11 is located in the first adjustment hole 1111, and a projection of the gravity center of the fixed disk 11 falls within the second adjustment hole 211.

During mounting, a fixing rope 63 passes through the fixing hole 1121 to realize fixing, and an adjustment rope 64 passes through the first adjustment hole 1111 and the second adjustment hole 211 in turn to realize adjustment. It is to be understood that when the claw device 100 is in operation, the adjustment rope 64 and the fixing rope 63 cooperate with each other to realize the movement and grasping-releasing action of the claw device 100. In some embodiments, referring to FIG. 9, a center axis of the second adjustment hole 211 and a center axis of the first adjustment hole 1111 are on the same straight line. Specifically, the fixed disk 11 includes a center region facing the center of the pivot plate 21 and an edge region 112 disposed along a periphery of the center region; the edge region 112 defines the fixing hole 1121; the center region defines the first adjustment hole 1111; and the pivot plate 21 defines the second adjustment hole 211 facing the first adjustment hole 1111. In some embodiments, the first adjustment hole 1111 and the second adjustment hole 211 are not in the same straight line. Specifically, the fixing hole 1121 and the first adjustment hole 1111 are located in the middle of the fixed disk 11, and the second adjustment hole 211 faces the gravity center of the fixed disk 11. The gravity center of the fixed disk 11 is located in the first adjustment hole 1111, and the positive projection of the gravity center of the fixed disk 11 falls into the region of the second adjustment hole 211, so as to cause the claw device 100 in the initial position to be in balance. In this way, it is easy for the game player to adjust the drop angle of the claw device 100 during the game, improving the grasping success rate.

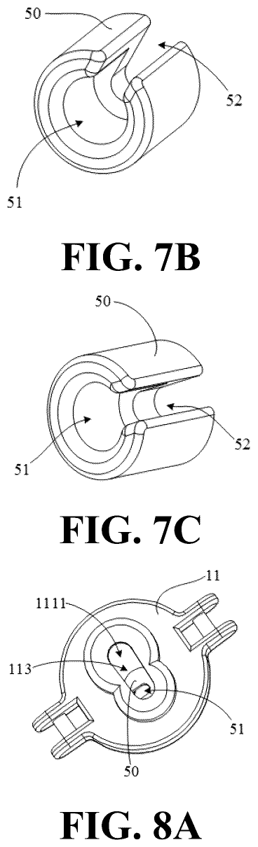

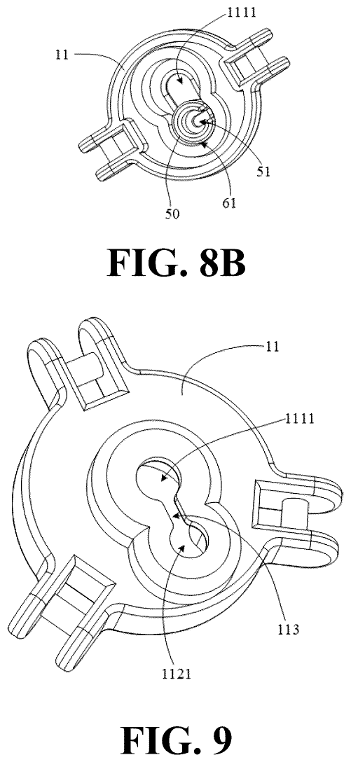

Further, referring to FIGS. 7A, 7B, 7C, and 8A and 8B, the claw device 100 further includes a limiting column 50. The limiting column 50 defines a limiting hole 51, and the limiting hole 51 runs through the limiting column 50 in the up-down direction. The limiting hole 51 is arranged with a mounting notch 52, and the width of the mounting notch 52 is less than the inner diameter of the limiting hole 51. A lower part of the fixing hole 1121 corresponds to the limiting column 50, and the aperture of the fixing hole 1121 is greater than the aperture of the limiting hole 51; or, another limiting column 50 is arranged corresponding to a lower side of the second adjustment hole 211, and the aperture of the second adjustment hole 211 is greater than the aperture of the limiting hole 51.

Currently, conventional crane machines often have the phenomenon of the fixing rope 63 and the adjustment rope 64 becoming entangled with each other when in use. For this reason, the gamer usually operates a controller to cause the claw device 100 to shake vigorously, thereby causing the fixing rope 63 and the adjustment rope 64 to untangle from each other. However, the violent shaking may cause the fixing rope 63 or the adjustment rope 64 to detach from the fixed disk 11 or the pivot plate 21. In addition, in order to ensure that the adjustment rope 64 or the fixing rope 63 moves smoothly in the up-down direction, the aperture diameters of the fixing hole 1121, the first adjustment hole 1111, or the second adjustment hole 211 are provided large enough. Such apertures mean that the range of movement of the fixing rope 63 or the adjustment rope 64 is also wider. When the claw device 100 has a tendency to tilt or when tilting occurs, the offset of the fixing rope 63 or the adjustment rope 64 may contribute to the tilt or exacerbate the tilting effect.

In the embodiments, the lower end of the fixing rope 63 or the adjustment rope 64 can be arranged on the limiting column 50 from the mounting notch 52. The width of the mounting notch 52 is less than the aperture of the limiting hole 51, such that the fixing rope 63 or the adjustment rope 64 can be moved inside the limiting hole 51, but cannot be easily detached from the limiting column 50. In case of wear and tear of a part or damage of the part, the mounting notch 52 facilitates the adjustment rope 64 or the fixing rope 64 to be separated from the limiting column 50 for replacement.

In some embodiments, the limiting column 50 is arranged below the fixing hole 1121, and the limiting column 50 may either not be connected to the fixed disk 11 or may be connected to the fixed disk 11, such as bonded, threaded, snap-fit, and the like. The aperture of the limiting hole 51 is less than the aperture of the fixing hole 1121, for limiting the range of movement of the fixing rope 63 and reducing the effect of the offset of the fixing rope 63 on the overall tilt of the claw device 100. In some embodiments, the limiting column 50 is arranged below the second adjustment hole 211, and the limiting column 50 may either not be connected to the pivot plate 21 or may be connected to the pivot plate 21, such as bonded, threaded, snap-fit, and the like. The aperture of the second adjustment hole 211 is greater than the aperture of the limiting hole 51, for limiting the range of movement of the adjustment rope 64 and reducing the effect of the offset of the adjustment rope 64 on the overall tilt of the claw device 100. In some embodiments, the limiting column 50 is arranged below each of the fixing hole 1121 and the second adjustment hole 211.

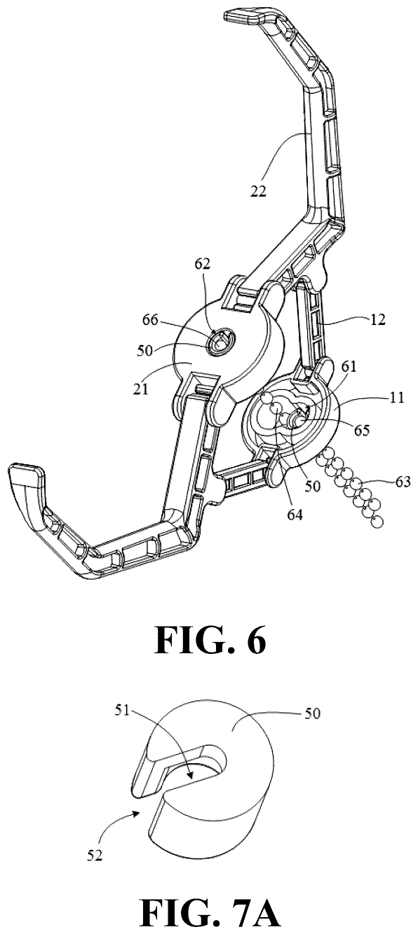

Further, referring to FIG. 6, a lower surface of the fixed disk 11 defines a first accommodation groove 61. The lower end of the fixing hole 1121 runs through the first accommodation groove 61, and the limiting column 50 is arranged in the first accommodation groove 61; a sidewall surface of the first accommodation groove 61 abuts against an outer peripheral surface of the limiting column 50 and closes or seals the mounting notch 52; a lower surface of the pivot plate 21 defines a second accommodation groove 62. The lower end of the second adjustment hole 211 runs through the second accommodation groove 62, and another limiting column 50 is arranged in the second accommodation groove 62; a sidewall surface of the second accommodation groove 62 abuts against the outer peripheral surface of the limiting column 50 and closes or seals the mounting notch 52.

In the embodiments, the lower surface of the fixed disk 11 defines a first accommodation groove 61, a lower end of the fixing hole 1121 runs through the first accommodation groove 61, and the limiting column 50 is arranged in the first accommodation groove 61, i.e., the lower end of the fixing rope 63 can pass through the fixing hole 1121, the first accommodation groove 61, and the limiting column 50 in turn, and be connected to the limiting column 50. A sidewall surface of the first accommodation groove 61 abuts against an outer peripheral surface of the limiting column 50, such that the limiting column 50 can be hidden and fixed in the first accommodation groove 61. In this way, the overall structure of the claw device 100 is more compact. The mounting notch 52 closed or sealed on the sidewall surface of the first accommodation groove 61 prevents the fixing rope 63 from detaching from the limiting column 50 even when the claw device 100 is shaken violently.

The lower surface of the pivot plate 21 defines a second accommodation groove 62, a lower end of the second adjustment hole 211 runs through the second accommodation groove 62, and the second accommodation groove 62 is arranged with another limiting column 50, i.e., the lower end of the adjustment rope 64 can pass through the first adjustment hole 1111, the second adjustment hole 211, the second accommodation groove 62, and the limiting column 50 in turn and be connected to the limiting column 50. The sidewall surface of the second accommodation groove 62 abuts against an outer peripheral surface of the limiting column 50, such that the limiting column 50 can be hidden and fixed in the second accommodation groove 62. In this way, the overall structure of the claw device 100 is more compact. The mounting notch 52 closed or sealed on the sidewall surface of the second accommodation groove 62 prevents the fixing rope 63 from detaching from the limiting column 50 even when the claw device 100 is shaken violently.

In some embodiments, the fixing rope 63 includes a first rope body and multiple first limiting balls 65 fixed to the first rope body and sequentially distributed along a length direction of the first rope body. The first rope body enters into the limiting hole 51 from the mounting notch 52, and the aperture diameter of the limiting hole 51 is greater than the diameter of each first limiting ball 65, such that an upward movement of the first rope body may be limited.

The adjustment rope 64 includes a second rope body and multiple second limiting balls 66 fixed on the second rope body and sequentially distributed along a length direction of the second rope body. The second rope body enters into the limiting hole 51 from the mounting notch 52, and the aperture of the limiting hole 51 is greater than the diameter of each second limiting ball 66, such that an end of the second rope body may be limited from disengaging from the pivot plate.

In some embodiments, the fixed disk 11 is further arranged with a connecting channel 113 that connects the fixing hole 1121 and the first adjustment hole 1111, and the connecting channel 113 runs through the fixed disk 11 in the up-down direction.

During movement, the claw device 100 may sway due to inertia, causing the claw device 100 to be skewed. Or, although the claw device 100 grasps the target subject, the gravity center of the target subject is not on the center axis of the claw device 100, causing the claw device 100 to be skewed. The skewing of the claw device 100 may easily cause the target subject to fall, reducing the grasping success rate of the claw device 100. In the embodiments, when the claw device 100 is skewed, a rope 40 may be biased to an un-skewed side through the connecting channel 113 to keep the claw device 100 balanced, avoiding the target subject from falling due to the skewing of the claw device 100. Taking the skewing of the claw device 100 towards the side with the fixing hole 1121 as an example, the adjustment rope 64 may be slightly skewed towards the first adjustment hole 1111 through the connecting channel 113 to restore the balance.

In some embodiments, the pivot plate 21 is arranged with a counterweight member, and the gravity center of the counterweight member coincides with the gravity center of the pivot plate 21 in the up-down direction.

The clamping rod 22 is pivotally connected to both the pivot plate 21 and the connecting rod 12. When the clamping rods 22 are separated from each other, the clamping rods 22 are affected by friction, and the opening angle between neighboring clamping rods 22 cannot be achieved as desired. When encountering a target subject with a large size, the clamping rod 22 may not be able to grab the target subject due to the insufficient opening angle, thereby discouraging the game player. In the embodiments, the pivot plate 21 is arranged with a counterweight member, and the gravity center of the counterweight member coincides with the gravity center of the pivot plate 21 in the up-down direction, which uniformly increases the weight of the pivot plate 21. In this way, the pivot plate 21 is further separated from the fixed disk 11 by gravity, thereby allowing the clamping rods 22 to open at a greater angle. In some embodiments, an upper surface of the pivot plate 21 defines a third accommodative groove 67. The third accommodation groove 67 is arranged around the gravity center of the pivot plate 21, and the counterweight member is arranged within the third accommodation groove 67. In some embodiments, the second adjustment hole 211 is arranged at the gravity center of the pivot plate 21, the third accommodation groove 67 is arranged around the second adjustment hole 211, and the counterweight is arranged in the third accommodation groove 67. In this way, it is possible to make the opening angle of the clamping rods 22 greater, and at the same time make the structure of the claw device 100 more compact.

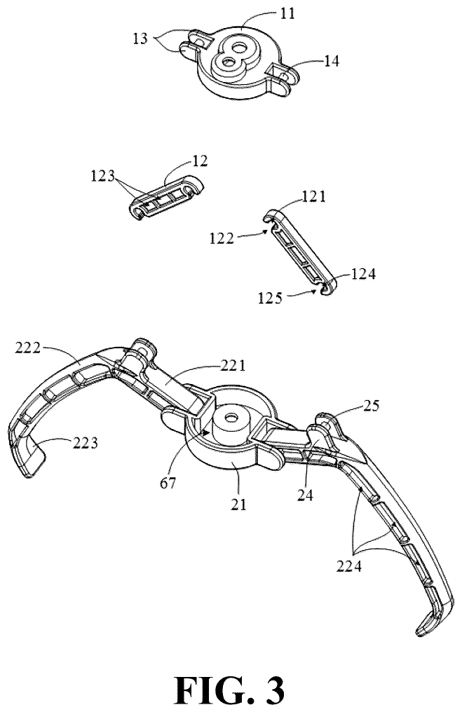

In some embodiments, referring to FIGS. 2 and 3, the adjustment assembly 10 includes at least two pairs of first tabs 13 spaced apart along the outer peripheral edge of the fixed disk 11 and a first rotating shaft 14 connecting each pair of first tabs 13; the connecting rod 12 defines a first shaft hole 121 at an end near the fixed disk 11, and a first notch 122 is arranged on an inner side of the connecting rod 12 corresponding to the first shaft hole 121; the first notch 122 is in communication with the first shaft hole 121; the first rotating shaft 14 is rotatably arranged in the first shaft hole 121 from the first notch 122; or
the actuating assembly 20 further includes two second tabs 24 disposed opposite each other on the connecting segment 221 and a second rotating shaft 25 connecting the two second tabs 24; the connecting rod 12 defines a second shaft hole 124 at an end near the connecting segment 221, and a second notch 125 is defined on an inner side of the connecting rod 12 corresponding to the second shaft hole 124; the second notch 125 is in communication with the second shaft hole 124; the second rotating shaft 25 is rotatably arranged in the second shaft hole 124 from the second notch 125.

Conventionally, in the pivot structure, the rotating shaft is inserted into the shaft hole, and a locking member is arranged at an end of the rotating shaft. Due to the small size of the locking member, the mounting thereof usually requires external tools, which reduces assembly efficiency to some extent. In addition, during use, the locking member is prone to loosening. After the locking member is loosened, the connecting rod 12 is unable to drive the clamping rod 22 normally, resulting in a lower grasping success rate of the claw device. In the proposed embodiments, the first rotating shaft 14 and the second rotating shaft 25 realize the rotational connection with the fixed disk 11 and the connecting segment 221 from the first notch 122 and the second notch 125, respectively. The assembly process is efficient and convenient without the use of external tools. In addition, the first tab 13 and the second tab 24 prevent the first shaft hole 121 and the second shaft hole 124, respectively, from detaching from the rotating shaft. Further, the first tab 13 and the second tab 24 will not be loosened during use, such that the clamping rod 22 is enabled to work properly.

In some embodiments, referring to FIGS. 2 and 3, each of sides of the clamping rod 22 adjacent to the first holding surface 2231 defines multiple first grooves 224 spaced apart along its length direction, or each of opposite sides of the connecting rod 12 defines multiple second grooves 123 spaced apart along its length direction.

Whether the claw device is balanced or not has a very important influence on the grasping success rate. Whether the mass of the clamping rod 22 and the connecting rod 12 is evenly distributed is crucial for the balance of the claw device. In some embodiments, the clamping rod 22 or the connecting rod 12 are made of plastic. Due to their certain thickness, the phenomenon of size shrinkage or hole shrinkage is likely to occur during manufacturing, resulting in uneven mass distribution of the clamping rod 22 or the connecting rod 12, which in turn affects the balance of the claw device. In the proposed embodiments, the hollowing out of the glue may be realized by defining grooves on the clamping rod 22 or the connecting rod 12 to avoid uneven mass distribution caused by the poor surface of the clamping rod 22 and/or the connecting rod 12, such that the balance of the claw device may not be affected.

The number of the second grooves 123 may be one, two or more. In some embodiments, the number of the second grooves 123 is three. The connecting rod 12 with three second grooves 123 may facilitate assembly by the visually impaired person. The visually impaired person can sense the number of the second grooves 123 by touching, so as to determine the position of the two ends of the connecting rod 12. In some embodiments, a side of the connecting rod 12 has a first notch 122. The visually impaired person can sense the number of the second notches 123 by touch and determine the position of the connecting rod 12 that he or she is holding relative to the position of the first notch. In this way, it is convenient for the visually impaired person to quickly mount the second rotating shaft 25 from the first notch 122 to the first shaft hole 121.

The present disclosure further proposes a crane machine, the crane machine includes a claw device 100, a driving device, and a rope 40, and the specific structure of the claw device 100 is referred to the above embodiments. Since the crane machine is adopted with all the technical solutions of all the above embodiments, it has at least all the beneficial effects brought about by the technical solutions of the above embodiments, which will not be repeated herein. The rope 40 connects the claw device 100 and the driving device; the driving device is configured to cause the fixed disk 11 and the pivot plate 21 of the claw device to be close to each other or far away from each other by driving the fixing rope 63; when the fixed disk 11 and the pivot plate 21 of the claw device are close to each other, the clamping rods 22 of the claw device are close to each other; when the fixed disk 11 and the pivot plate 21 of the claw device are far away from each other, the clamping rods 22 are far away from each other.

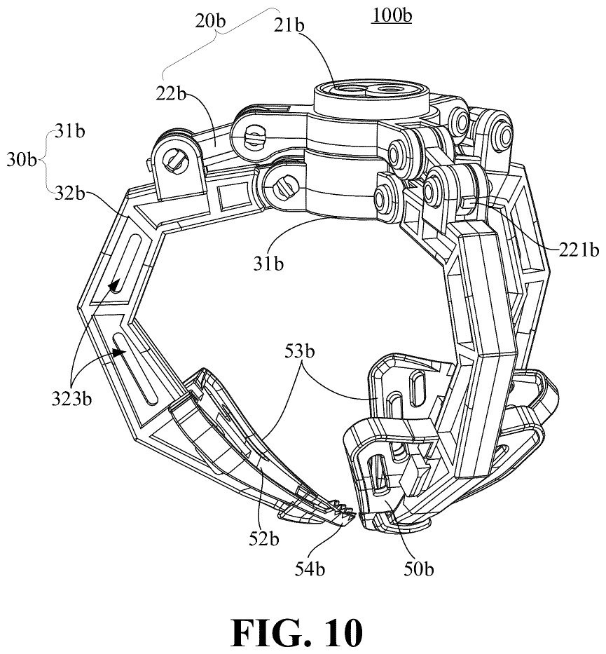

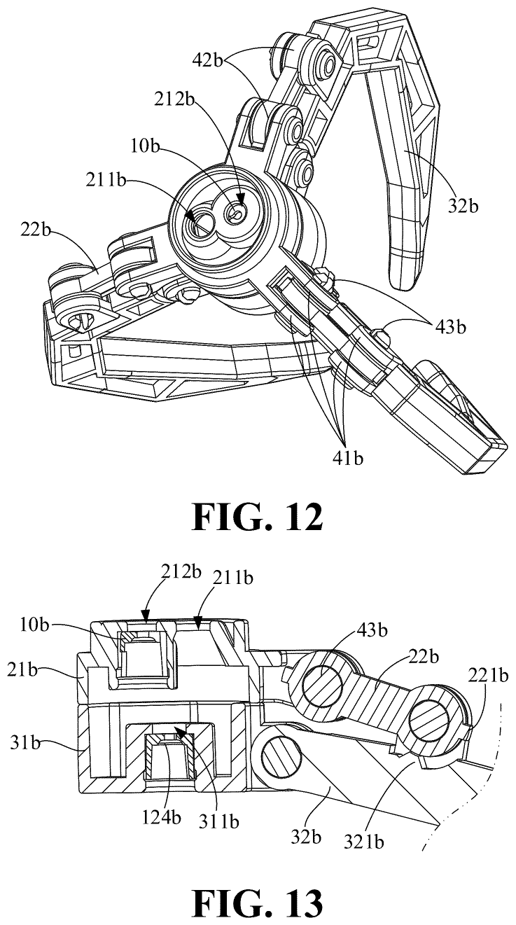

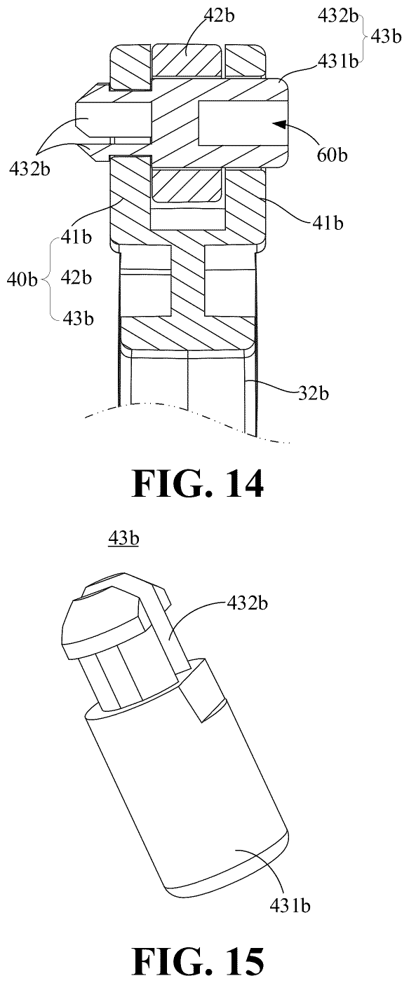

In some embodiments, referring to FIGS. 10 to 17, a gripper for a crane machine includes a limiting sleeve 10b, an adjustment assembly 20b, and an actuating assembly 30b.

The limiting sleeve 10b defines an opening 11b on an end in the axial direction thereof and is arranged with an end wall 12b at the other end; the end wall 12b is arranged with a first channel 125b, and a side wall of the limiting sleeve 10b is arranged with a second channel 13b communicating with the first channel 125b.

The adjustment assembly 20b includes a fixed disk 21b and at least two connecting rods 22b arranged at intervals along an outer periphery of the fixed disk 21b; the fixed disk 21b defines a first adjustment hole 211b and a fixing hole 212b, both of which extend along an up-down direction and through the fixed disk 21b; the first adjustment hole 211b and the fixing hole 212b allow a bead chain to move up and down.

The actuating assembly 30b is movably connected to the adjustment assembly 20b; the actuating assembly 30b includes a pivot plate 31b arranged below the fixed disk 21b and at least two clamping rods 32b arranged at intervals along an outer periphery of the pivot plate 31b; the pivot plate 31b defines a second adjustment hole 311b arranged in the center and extending along the up-down direction and through the pivot plate 31b, and the second adjustment hole 311b allows the bead chain to move up and down; an end of the connecting rod 22b is movably connected to the fixed disk 21b, and the other end of the connecting rod 22b is movably connected to the clamping rod 32b; an end of the clamping rod 32b is movably connected to the pivot plate 31b, and tail ends of the adjacent clamping rods 32b are brought together or separated to open or close the gripper.

The limiting sleeve 10b is arranged below the fixing hole 212b, a diameter of the fixing hole 212b being greater than a maximum width of the first channel 125b, and the limiting sleeve 10b is engaged with the fixed disk 21b; or, another limiting sleeve 10b is arranged below the second adjustment hole 311b, the diameter of the second adjustment hole 311b being greater than the maximum width of the first channel 125b, and the limiting sleeve 10b is engaged with the pivot plate 31b.

In the above embodiments, the gripper of the crane machine refers to a part of the crane machine that can simulate the opening and closing of a hand to grab toys such as dolls and puppets.

The adjustment assembly 20b refers to a part, of the gripper of the crane machine, that can drive the movement of other parts to complete the opening or closing action. The adjustment assembly 20b includes a fixed disk 21b and at least two connecting rods 22b spaced along the outer periphery of the fixed disk 21b; the connecting rods 22b may be two, three, four, etc. in number. An end of the connecting rod 22b is movably connected to the fixed disk 21b, and the other end of the connecting rod 22b is movably connected to the connecting segment. The gripper of the crane machine moves relative to the fixed disk 21b and the pivot plate 31b by adjusting the height difference between the fixed disk 21b and the pivot plate 31b. Since the connecting rod 22b is movably connected to the connecting segment, the connecting rod 22b drives the connecting segment to move, thereby causing multiple clamping members to separate from each other or move closer to each other to complete the action of simulating the opening and closing of a hand.

The actuating assembly 30b refers to a part of the gripper 100b of the crane machine that directly performs the opening or closing action. The actuating assembly 30b includes a pivot plate 31b arranged below the fixed disk 21b and at least two clamping rods 32b spaced along the outer periphery of the pivot plate 31b. The number of the clamping rods 32b corresponds to the number of the connecting rods 22b, and the number of clamping rods 32b may be two, three, four, etc.

The limiting sleeve 10b is configured to limit the position of the bead chain to improve the success rate of gripping by the gripper. In some embodiments, the limiting sleeve 10b is only arranged below the fixing hole 212b or the second adjustment hole 311b; in other embodiments, several limiting sleeves 10b are arranged below the fixing hole 212b and the second adjustment hole 311b. The opening 11b, the second channel 13b, and the first channel 125b in the limiting sleeve 10b provide an installation path for the bead chain. The bead chain includes several beads and a string connecting the beads in series. The end wall 12b is configured to abut against the bead at one end of the bead chain, thereby restricting the upward movement of the bead out of the limiting sleeve 10b.

During the mounting process, the beads are placed in the opening 11b at an end of the limiting sleeve 10b, and the string between adjacent beads is aligned with the second channel 13b; the chain is moved along the second channel 13b until the beads abut against the end wall 12b; the beads are caused to move along the first channel 125b; the limiting sleeve 10b is arranged below the fixing hole 212b or the second adjustment hole 311b, such that the hole wall of the fixing hole 212b or the second adjustment hole 311b blocks the first channel 125b, and thus the bead chain will not fall out of the first channel 125b even when subjected to severe shaking. The snap fit between the limiting sleeve 10b and the fixed disk 21b or pivot plate 31b ensures that the gripper 100b maintains a state in which the hole wall of the fixing hole 212b or second adjustment hole 311b blocks the first channel 125b during use, such that the bead chain cannot fall out of the limiting sleeve 10b for a long time.

To ensure that the bead chain can be smoothly passed through the fixing hole 212b or the second adjustment hole 311b during the mounting process, in a conventional crane machine, the diameter of the fixing hole 212b or the second adjustment hole 311b is set to be sufficiently large, which means that the bead chain has a relatively wide range of movement. However, when the gripper tends to tilt or does tilt, the deflection of the bead chain through the fixing hole 212b or the second adjustment hole 311b may cause or exacerbate the tilting effect, resulting in a low success rate of gripping by the gripper. In addition, when the crane machine is in use, the bead chains through the fixing hole 212b and the first adjustment hole 211b often become entangled with each other. For this reason, the player will often operate the controller to cause the gripper to shake violently, such that the entangled bead chains can be unknotted. However, violent shaking may cause the bead chains to detach from the fixed disk 21b or the pivot plate 31b.

In the present embodiments, the gripper of the crane machine may solve the problem of the gripper tilting easily and the success rate of grasping objects being not high due to the oversize of the diameter of the fixing hole 212b or the second adjustment hole 311b through the setting of the limiting sleeve 10b. The diameter of the fixing hole 212b or the second adjustment hole 311b is greater than the maximum width of the first channel 125b, i.e., the maximum width of the first channel 125b is less than the diameter of the fixing hole 212b or the second adjustment hole 311b. When the bead chain is mounted in the limiting sleeve 10b, the swing range of the bead chain is limited by the width of the first channel 125b, which limits the swing range of the bead chain, thereby making it less likely for the gripper to become unbalanced, and thus improving the success rate of the gripper in grasping objects. Compared with the situation where the diameter of the fixing hole 212b or the second adjustment hole 311b is reduced to limit the swing range of the bead chain, the present embodiments make installation more convenient and efficient. Specifically, one end of the bead chain is connected to a driving device, and the other end is first passed through the fixing hole 212b or the second adjustment hole 311b, and then mounted in the limiting sleeve 10b; next, the limiting sleeve 10b is snapped onto the fixed disk 21b or the pivot plate 31b. In contrast, reducing the diameter of the fixing hole 212b or the second adjustment hole 311b makes it significantly more difficult to thread the bead chain through the fixing hole 212b or the second adjustment hole 311b, which significantly reduces assembly efficiency.

In addition, in the present disclosure, the relative position of one end of the bead chain to the fixed disk 21b or the pivot plate 31b is made stable by means of the end wall 12b, and interlocking between the limiting sleeve 10b and the fixed disk 21b or the pivot plate 31b, so as to prevent the bead chain from detaching from the fixed disk 21b or the pivot plate 31b when impacted by external force.

Further, an inner wall of the first channel 125b is arranged with an anti-disconnecting member 122b protruding from a middle position along its extension direction, to prevent the bead chain from disengaging from the limiting sleeve 10b. The anti-disconnecting member 122b may assist in the pre-installation of the bead chain and the limiting sleeve 10b, thereby preventing the bead chain from disengaging from the limiting sleeve 10b along the first channel 125b before the limiting sleeve 10b is mounted on the fixed disk 21b or the pivot plate 31b. The anti-disconnecting member 122b may include one or more pieces, and the specific number and form are not limited herein.

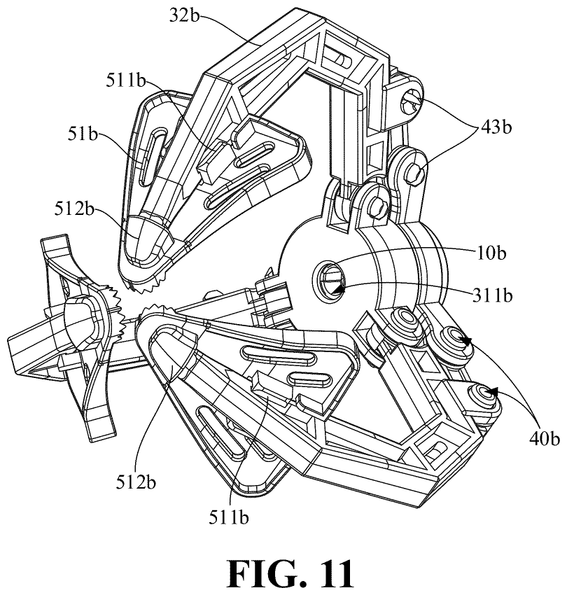

Further, referring to FIGS. 11, 13, 16 and 17, the anti-disconnecting member 122b includes two limiting protrusions 1221 arranged opposite each other, and the two limiting protrusions 1221 are arranged at intervals to form a slit 123b; the limiting protrusions 1221 and an inner wall surface of the first channel 125b enclose to define a mounting hole 121b adapted to the bead chain; the slit 123b has a width that is less than the diameter of the mounting hole 121b, and the slit 123b is connected to the mounting hole 121b and the second channel 13b.

In the embodiments, the limiting protrusion 1221 and the inner wall surface of the first channel 125b enclose to define the mounting hole 121b adapted to the bead chain, such that after the bead chain is mounted, the bead at one end of the bead chain abuts against the inner surface of the end wall 12b, preventing the bead chain from coming off the limiting sleeve 10b upwards; at the same time, the chain is allowed to swing within the mounting hole 121b.

The slit 123b is connected to the mounting hole 121b and second channel 13b, providing the bead chain with a mounting path from the second channel 13b to the mounting hole 121b. The width of the slit 123b is less than the diameter of the mounting hole 121b, such that the bead chain can move in the mounting hole 121b under normal circumstances, but it is difficult for the bead chain to escape from the slit 123b, thereby effectively preventing the bead chain from accidentally disengaging from the limiting sleeve 10b, and further enhancing the stability and reliability of the bead chain in the limiting sleeve 10b. This allows the movement of the bead chain to more accurately control the closing or separation of the clamping rod 32b, thereby achieving precise grasping of objects and improving the success rate of grasping the objects.

In some embodiments, referring to FIGS. 13 and 17, an inner surface of the end wall 12b defines a recess 124b, and the first channel 125b is disposed in the recess 124b.

Compared with a situation where the inner surface of the end wall 12b is flat, in the above embodiments, the inner surface of the end wall 12b is provided with the recess 124b, which effectively buffers the impact force generated during the movement of the bead chain and reduces the frictional loss between the bead chain and the inner surface of the end wall 12b. In addition, the shape and size of the recess 124b may play a certain positioning role on the beads, such that the position of the bead chain in the first channel 125b is more stable, reducing the offset of the bead chain in the length direction of the first channel 125b, thereby avoiding excessive offset of the crane machine, which would cause the success rate of grasping to decrease.

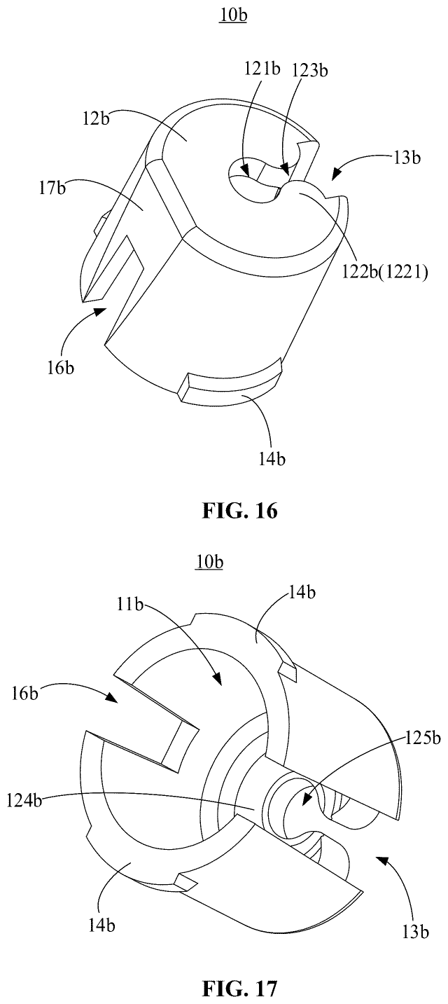

In some embodiments, referring to FIGS. 16 and 17, an outer side wall of the limiting sleeve 10b is arranged with a first snap-fit portion 14b, and the fixed disk 21b or the pivot plate 31b is arranged with a second snap-fit portion that is adapted to the first snap-fit portion 14b; one of the first snap-fit portion 14b and the second snap-fit portion is a convex portion, and the other is a groove.

In the embodiments, the first snap-fit portion 14b and the second snap-fit portion form a stable connection between the limiting sleeve 10b and the fixed disk 21b or the pivot plate 31b, thereby improving the stability of the entire gripper, reducing the risk of performance degradation or failure of the gripper due to loose parts or loose connections, and thus ensuring the reliability of the crane machine during long-term use.

Furthermore, the limiting sleeve 10b is arranged with a second channel 13b and an avoidance notch 16b on both sides along its axial direction; the outer side wall of the limiting sleeve 10b includes a guide bevel 17b, and the avoidance notch 16b is disposed on the guide bevel 17b; the first snap-fit portion 14b includes at least two protrusions, and the protrusions are disposed on both sides of the second channel 13b or the avoidance notch 16b.

Interference may occur during snap-fitting of the limiting sleeve 10b with the fixed disk 21b or the pivot plate 31b, resulting in unsuccessful or inaccurate installation. The second channel 13b and the avoidance notch 16b cause the sidewalls of the limiting sleeve 10b to undergo an appropriate elastic deformation during installation, ensuring accurate installation of the limiting sleeve 10b. The second channel 13b and the avoidance notch 16b are arranged on both sides of the limiting sleeve 10b in the axial direction of the limiting sleeve 10b, such that the elastic deformation of the side wall of the limiting sleeve 10b is more uniform, and irreversible damage to the limiting sleeve 10b caused by the elastic deformation may be prevented. The guide bevel 17b serves to guide the installation. The first snap-fit portion 14b includes at least two protrusions, and the multi-point engagement is more stable than the single-point engagement. The protrusion may be a protruding strip extending along a peripheral direction of the limiting sleeve 10b, or a catch. Here, the specific shape of the protrusion is not limited.

In some embodiments, the width of the second channel 13b is less than the width of the first channel 125b. Thus, after the bead chain is mounted in the first channel 125b, it is restricted by the second channel 13b and is not easily disengaged from the limiting sleeve 10b, thereby assisting in the pre-installation of the limiting sleeve 10b with the bead chain.

The pivot structure is a key component for opening and closing the multiple clamping rods 32b. The pivot structure includes a fixing post 431b and a deformable part connected to each other, where the fixing post 431b and the deformable part are arranged along an axial direction of the fixing post 431b. The fixing post 431b serves as a main supporting part of the pivot structure and plays a role in fixing and connecting. The deformable part can deform when passing through the connecting rod 22b/fixed disk 21b/pivot plate 31b/clamping rod 32b, allowing it to pass through smoothly, and then restore its shape and be limited in the axial direction of the fixing post 431b with the connecting rod 22b/fixed disk 21b/pivot plate 31b/clamping rod 32b. The specific shape of the deformable part is not limited herein.

Compared to a pivot structure that requires fasteners such as nuts and bolts, the pivot structure of the present embodiments does not require cumbersome tightening operations using tools during assembly. When the fixing post 431b is simply inserted into the connecting rod 22b/fixed disk 21b/pivot plate 31b/clamping rod 32b, the deformable part will automatically lock with the connecting rod 22b/fixed disk 21b/pivot plate 31b/clamping rod 32b. In contrast, the pivot structure using nuts and bolts requires the use of tools for disassembly and assembly, which is more cumbersome, and may increase the difficulty of disassembly due to rust or damage to the nuts and bolts.

Compared with a pivot structure of the hook type, the pivot structure of the present embodiments may achieve a more precise pivoting movement. The pivot structure of the hook type may have a large gap between the hook and the pivot rod, which causes the pivoting to shake, affecting the pivoting accuracy. However, the plug-in connection of the fixing post 431b and the limit of an elastic catch 432b in the embodiments may ensure that the relative position between the fixing post 431b and the connecting rod 22b/fixed disk 21b/pivot plate 31b/clamping rod 32b remains stable, such that the pivoting movement can follow the designed path, thereby reducing unnecessary deviations, improving the accuracy of the pivoting movement, and in turn helping to improve the accuracy and success rate of grasping objects.

In the present disclosure, mounting may be completed without the aid of external tools due to the deformable nature of the deformable part of the pivot structure. In addition, the accuracy and success rate of the gripper of the crane machine may be improved by inserting the fixing post 431b to maintain the relative position between the fixing post 431b and the connecting rod 22b/fixed disk 21b/pivot plate 31b/clamping rod 32b stable, thereby improving the precision of the pivot.

Further, the pivot structure includes two opposing bosses 41b, and a pivot tab 42b sandwiched between the two bosses 41b; the bosses 41b and the pivot tab 42b each define a through hole; the deformable part includes at least two elastic catches 432b arranged at one end of the fixing post 431b, and the elastic catches 432b are arranged along the axial direction of the fixing post 431b; the fixing post 431b is inserted into the through hole, and the elastic catch 432b is engaged with the boss 41b in the axial direction of the fixing post 431b; one of the connecting rod 22b and the fixed disk 21b is arranged with two bosses 41b arranged opposite each other, and the other is arranged with the pivot tab 42b; or, one of the connecting rod 22b and the clamping rod 32b is arranged with two bosses 41b arranged opposite each other, and the other is arranged with the pivot tab 42b; or, one of the clamping rod 32b and the pivot plate 31b is arranged with two bosses 41b arranged opposite each other, and the other is arranged with the pivot tab 42b.

In the embodiments, the elastic catch 432b undergoes elastic deformation when passing through the through hole to allow it to pass through the through hole smoothly, and after passing through, it resumes elastic deformation and snaps with the boss 41b; at this time, the fixing post 431b is inserted in the through hole. In this way, the pivot structure can be installed without the need for external tools.

In some embodiments, the fixing post 431b has an internal cavity. During the injection molding process, the plastic material shrinks during cooling, a phenomenon known as shrinkage. Shrinkage may cause dimensional deviations, surface depressions, insufficient strength, and other problems in the molded part. The design of the fixing post 431b with a cavity may effectively alleviate the problem of shrinkage, such that the fixing post 431b maintains a smooth outer surface, which in turn allows the fixing post 431b to rotate flexibly within the through hole, thereby improving the pivot accuracy. In addition, the cavity design may significantly reduce the weight of the fixing post 431b. In the pivot structure, the lighter fixing post 431b may reduce the inertia of movement, making the entire pivot structure more flexible and responsive during movement. This flexibility helps to improve the movement accuracy of the pivot structure, especially in devices such as the gripper of the crane machine that require rapid adjustment and frequent movement.

In some embodiments, an end of the fixing post 431b away from the elastic catch 432b extends beyond the surface of the boss 41b in the axial direction of the fixing post 431b. When the end of the fixing post 431b extends beyond the surface of the boss 41b, a more spacious gripping space is provided for the user. This design makes it easier for the user to grip the fixing post 431b with their fingers without being disturbed by the boss 41b. The overhang allows the user to exert force more easily when operating, whether rotating, pulling or pushing, and to control the force and direction more precisely.

In some embodiments, referring to FIG. 13, the connecting rod 22b and the clamping rod 32b are rotatably connected. An end of the connecting rod 22b close to the clamping rod 32b is arranged with a first abutment protrusion 221b, and a second abutment protrusion 321b adapted to the first abutment protrusion 221b is arranged on the clamping rod 32b; the second abutment protrusion 321b is arranged relative to the first abutment protrusion 221b close to the central axis of the pivot plate 31b; the second abutment protrusion 321b is located in the movement path of the first abutment protrusion 221b such that the first abutment protrusion 221b can be rotated to abut against the second abutment protrusion 321b.

In the embodiments, the rotatable connection between the connecting rod 22b and the clamping rod 32b enables the clamping rod 32b to rotate relative to the connecting rod 22b, which is the basis for the opening and closing action of the gripper. The mutual fit of the first abutment protrusion 221b and the second abutment protrusion 321b allows the relative rotation angle between the connecting rod 22b and the clamping rod 32b to be precisely controlled, thereby precisely controlling the degree of opening and closing of the gripper. When the first abutment protrusion 221b abuts against the second abutment protrusion 321b during operation of the crane machine, a limit position of the opening and closing of the gripper is reached, thereby avoiding structural damage due to excessive opening and closing or the problem of being unable to effectively grasp objects, so as to improve the operating accuracy and reliability of the gripper.

In some embodiments, a first tooth is arranged on an end of the clamping rod 32b facing the central axis of the pivot plate 31b. In this way, when adjacent clamping rods 32b are brought together, the first teeth on the multiple clamping rods 32b can mesh with each other to form a tighter gripping structure, which helps to firmly grasp the object. For some objects with smooth surfaces or irregular shapes, the first teeth may provide additional friction and grip force to prevent the object from slipping during the gripping process, thereby reducing the number of gripping failures and improving the success rate of gripping objects.

In some embodiments, referring to FIGS. 10 and 11, the crane machine includes a pallet 50b that is removably mounted on the tail end of the clamping rod 32b; the pallet 50b includes a third clamping surface 52b disposed towards the central axis of the pivot plate 31b and a third holding surface 51b disposed opposite the third clamping surface 52b; the third holding surface 51b is attached on a plane of the clamping rod 32b that is close to the central axis of the pivot plate 31b; the pallet 50b further includes an enclosure 53b that is arranged around the edge of the third clamping surface 52b.

In the embodiments, the pallet 50b is removably mounted on the tail end of the clamping rod 32b, providing the gripper of the crane machine with the possibility of functional expansion. When different types of objects are required to be grabbed, different pallets 50b can be replaced according to actual needs, thereby improving the adaptability and flexibility of the crane machine. For example, for larger, thinner, or specially shaped objects, the gripping task may be better completed and the success rate of gripping may be improved by replacing with a suitable pallet 50b.

The third clamping surface 52b may come into direct contact with the object. By adjusting its shape and material, it may better adapt to different object surfaces and provide better gripping results. The third holding surface 51b is attached to the plane of the clamping rod 32b near the central axis of the pivot plate 31b and provides a foundation for the installation and support of the pallet 50b, ensuring that the pallet 50b can be stably attached to the clamping rod 32b during use.

The enclosure 53b is attached around the edge of the clamping surface, preventing objects from slipping sideways. When grasping objects that are small or tend to roll, the enclosure 53b may restrict the objects to the area of the pallet 50b, preventing them from rolling sideways during the grasping process, thereby further enhancing the grasping function of the pallet 50b.

In some embodiments, referring to FIG. 11, the crane machine includes a pallet 50b that is removably mounted on the tail end of the clamping rod 32b; the pallet 50b includes a third clamping surface 52b arranged towards the central axis of the pivot plate 31b and a third holding surface 51b arranged opposite the third clamping surface 52b; the third holding surface 51b is attached on a plane of the clamping rod 32b that is close to the central axis of the pivot plate 31b; the third holding surface 51b is arranged with a limiting catch 511b and an assembly groove 512b; the limiting catch 511b and the assembly groove 512b are distributed along the extension direction of the clamping rod 32b; a rod body of the clamping rod 32b is engaged with the limiting catch 511b, and the tail end of the clamping rod 32b is inserted into the assembly groove 512b.

In the embodiments, the limiting catch 511b and the assembly groove 512b are distributed along the extension direction of the clamping rod 32b, such that the pallet 50b may be evenly stressed in the extension direction of the clamping rod 32b, avoiding the pallet 50b from loosening or falling off due to stress during the gripping process, and ensuring the safety and reliability of the gripping operation. In addition, the assembly groove 512b allows the tail end of the clamping rod 32b to be inserted, which not only further ensures the correct installation position of the pallet 50b, but also makes the connection between the pallet 50b and the clamping rod 32b more closely and firmly, thereby preventing the pallet 50b from falling off the clamping rod 32b when it is subjected to a large load. Furthermore, the peripheral wall of the assembly groove 512b may prevent an end of the pallet 50b from skewing due to uneven stress.

In some embodiments, referring to FIGS. 10 and 11, the crane machine includes a pallet 50b that is removably mounted on the tail end of the clamping rod 32b, and an end of the pallet 50b includes a second tooth 54b that is protruding towards the central axis of the pivot plate 31b.

In the embodiments, when adjacent clamping rods 32b are brought together, the pallets 50b on the clamping rods 32b also move closer to each other, and the second teeth 54b on the pallets 50b can mesh with each other to form a tighter gripping structure, which helps to firmly grasp the object. For some objects with smooth surfaces or irregular shapes, the second teeth 54b can provide additional friction and grip, preventing the object from slipping during the gripping process, thereby reducing the number of gripping failures and improving the success rate of gripping objects.

In some embodiments, referring to FIG. 10, a through hole 323b is defined on a middle portion of the clamping rod 32b, and the aperture of the through hole 323b extends along the extension direction of the clamping rod 32b. Thus, during transportation, nylon ties, ropes, etc., can be passed through the through hole 50b on each clamping rod 32b to cause the clamping rods 32b to move closer to each other and be fixed, thereby preventing the clamping rods 32b from colliding and being damaged due to bumps.

The present disclosure further proposes a crane machine, including a bead chain, a driving device, and a gripper. The specific structure of the gripper refers to the above embodiments. Since the crane machine adopts all the technical solutions of all the above embodiments, it has at least all the beneficial effects brought about by the technical solutions of the above embodiments, which will not be described in detail herein. The bead chain connects the gripper and the driving device; the driving device causes the fixed disk 21b and the pivot plate 31b of the gripper to move closer to or further away from each other by driving the bead chain; when the fixed disk 21b and the pivot plate 31b of the gripper move closer to each other, the clamping rods 32b of the gripper move closer to each other; and when the fixed disk 21b and the pivot plate 31b of the gripper move away from each other, the clamping rods 32b of the gripper move away from each other.

Finally, it should be noted that the above embodiments are only intended to illustrate the technical solutions of the present disclosure, and not to limit them. Although the present disclosure has been described in detail with reference to the foregoing embodiments, those skilled in the art should understand that it is still possible to make modifications to the technical solutions recorded in the foregoing embodiments, or to make equivalent replacements for some of the technical features therein. These modifications or substitutions do not cause the essence of the technical solutions to depart from the spirit and scope of the technical solutions of the embodiments in the present disclosure.

What is claimed is:

1. A claw device for a crane machine, comprising an adjustment assembly and an actuating assembly movably connected to the adjustment assembly;
wherein the adjustment assembly comprises a fixed disk and at least two connecting rods spaced apart along an outer peripheral edge of the fixed disk;
the actuating assembly comprises a pivot plate disposed below the fixed disk and at least two clamping rods spaced apart along an outer peripheral edge of the pivot plate; a viewing window is formed between each adjacent two of the at least two clamping rods;
each clamping rod comprises a connecting segment, a fixed segment, and a holding segment that are sequentially connected; the connecting segment is movably connected to the pivot plate; the fixed segment comprises a first clamping surface toward a center axis of the pivot plate;
the holding segment extends toward the center axis of the pivot plate from a lower end of the fixed segment;
the holding segment comprises a first holding surface toward the center axis of the pivot plate; the first holding surface is connected to the first clamping surface, and the first holding surface and the first clamping surface are arranged at an angle;
an end of each connecting rod is movably connected to the fixed disk, and the other end of the connecting rod is movably connected to the connecting segment of a corresponding clamping rod;
wherein the fixed disk defines a first adjustment hole and a fixing hole, and the first adjustment hole and the fixing hole both pass through the fixed disk in an up-down direction; the pivot plate defines a second adjustment hole, and the second adjustment hole passes through the pivot plate in the up-down direction;
a gravity center of the fixed disk is located in the first adjustment hole, and a projection of the gravity center of the fixed disk falls within the second adjustment hole;
wherein the claw device further comprises a limiting column; the limiting column defines a limiting hole, and the limiting hole runs through the limiting column in the up-down direction; the limiting hole is arranged with a mounting notch, and a width of the mounting notch is less than an inner diameter of the limiting hole; wherein,
a lower part of the fixing hole corresponds to the limiting column, and an aperture of the fixing hole is greater than an aperture of the limiting hole; or
another the limiting column is arranged corresponding to a lower side of the second adjustment hole, and an aperture of the second adjustment hole is greater than an aperture of the limiting hole.

2. The claw device according to claim 1, wherein a lower surface of the fixed disk defines a first accommodation groove; a lower end of the fixing hole runs through the first accommodation groove, and the limiting column is arranged in the first accommodation groove; a sidewall surface of the first accommodation groove abuts against an outer peripheral surface of the limiting column and closes or seals the mounting notch of the limiting column.

3. The claw device according to claim 1, wherein a lower surface of the pivot plate defines a second accommodation groove; a lower end of the second adjustment hole runs through the second accommodation groove, and the other limiting column is arranged in the second accommodation groove; a sidewall surface of the second accommodation groove abuts against an outer peripheral surface of the other limiting column and closes or seals the mounting notch of the other limiting column.

4. A gripper for a crane machine, comprising:
an adjustment assembly, comprising a fixed disk and at least two connecting rods arranged at intervals along an outer periphery of the fixed disk; wherein the fixed disk defines a first adjustment hole and a fixing hole, and the first adjustment hole and the fixing hole both extend along an up-down direction and through the fixed disk; the first adjustment hole and the fixing hole are configured for a bead chain to move up and down;
an actuating assembly, movably connected to the adjustment assembly; wherein the actuating assembly comprises a pivot plate arranged below the fixed disk and at least two clamping rods arranged at intervals along an outer periphery of the pivot plate; a middle portion of the pivot plate defines a second adjustment hole extending along the up-down direction and through the pivot plate, and the second adjustment hole is configured for the bead chain to move up and down; an end of each connecting rod is movably connected to the fixed disk, and another end of the connecting rod is movably connected to a corresponding clamping rod; an end of each clamping rod is movably connected to the pivot plate; tail ends of each adjacent two of the at least two clamping rods are capable of moving together and of moving separated to achieve an opening-closing function of the gripper; and
a limiting sleeve; wherein the limiting sleeve defines an opening on an end along an axial direction of the limiting sleeve and is arranged with an end wall at an opposite end; the end wall is arranged with a first channel, and a side wall of the limiting sleeve is arranged with a second channel communicating with the first channel;
wherein the limiting sleeve is arranged below the fixing hole, a diameter of the fixing hole being greater than a maximum width of the first channel of the limiting sleeve; or, another the limiting sleeve is arranged below the second adjustment hole, a diameter of the second adjustment hole being greater than a maximum width of the first channel of the other limiting sleeve.

5. The gripper according to claim 4, wherein an inner wall of the first channel is arranged with an anti-disconnecting member protruding from a middle position along an extension direction of the first channel, to prevent the bead chain from disengaging from the limiting sleeve.

6. The gripper according to claim 5, wherein the anti-disconnecting member comprises two limiting protrusions arranged opposite each other, and the two limiting protrusions are arranged at intervals to define a slit; the two limiting protrusions and an inner wall surface of the first channel enclose to define a mounting hole adapted to the bead chain; a width of the slit is less than a diameter of the mounting hole, and the slit is connected to the mounting hole and the second channel.

7. The gripper according to claim 4, wherein an inner surface of the end wall defines a recess, and the first channel is disposed in the recess.

8. The gripper according to claim 4, wherein an outer side wall of the limiting sleeve is arranged with a first snap-fit portion, and the fixed disk or the pivot plate is arranged with a second snap-fit portion that is adapted to the first snap-fit portion; one of the first snap-fit portion and the second snap-fit portion is a convex portion, and the other of the first snap-fit portion and the second snap-fit portion is a convex portion is a groove.

9. The gripper according to claim 8, wherein the limiting sleeve is arranged with the second channel and an avoidance notch on opposite sides along the axial direction; the outer side wall of the limiting sleeve comprises a guide bevel, and the avoidance notch is disposed on the guide bevel; the first snap-fit portion comprises at least two protrusions, and the at least two protrusions are disposed on opposite sides of the second channel or the avoidance notch.

10. The gripper according to claim 4, wherein a width of the second channel is less than a width of the first channel.

11. The gripper according to claim 4, wherein the gripper further comprises a pivot structure comprising a fixing post and a deformable part connected to each other, and the fixing post and the deformable part are arranged along an axial direction of the fixing post;
wherein the fixing post and the deformable part pass through a corresponding connecting rod and the fixed disk, and the deformable part as well as the corresponding connecting rod or the fixed disk are limited in the axial direction of the fixing post; or,
the fixing post and the deformable part pass through a corresponding connecting rod and a corresponding clamping rod, and the deformable part as well as the corresponding connecting rod or the corresponding clamping rod are limited in the axial direction of the fixing post; or,
the fixing post and the deformable part pass through a corresponding clamping rod and the pivot plate, and the deformable part as well as the corresponding clamping rod or the pivot plate are limited in the axial direction of the fixing post.

12. The gripper according to claim 11, wherein the pivot structure further comprises two opposing bosses, and a pivot tab sandwiched between the two bosses; the two bosses and the pivot tab each define a through hole; the deformable part comprises at least two elastic catches arranged on an end of the fixing post, and the at least two elastic catches are arranged along the axial direction of the fixing post; the fixing post is inserted into the through hole, and the at least two elastic catches are engaged with the two bosses in the axial direction of the fixing post;
wherein one of a corresponding connecting rod and the fixed disk is arranged with the two bosses arranged opposite each other, and the other of the corresponding connecting rod and the fixed disk is arranged with the pivot tab; or,
one of a corresponding connecting rod and the clamping rod is arranged with the two bosses, and the other of the corresponding connecting rod and the clamping rod is arranged with the pivot tab; or,
one of a corresponding clamping rod and the pivot plate is arranged with the two bosses, and the other of the corresponding clamping rod and the pivot plate is arranged with the pivot tab.

13. The gripper according to claim 12, wherein an end of the fixing post away from the at least two elastic catches extends beyond a surface of the two bosses in the axial direction of the fixing post.

14. The gripper according to claim 11, wherein the fixing post has an internal cavity.

15. The gripper according to claim 4, wherein each connecting rod and a corresponding clamping rod are rotatably connected; an end of the connecting rod close to the corresponding clamping rod is arranged with a first abutment protrusion, and a second abutment protrusion adapted to the first abutment protrusion is arranged on the corresponding clamping rod; the second abutment protrusion is arranged relative to the first abutment protrusion close to a central axis of the pivot plate; the second abutment protrusion is located in a movement path of the first abutment protrusion, and the first abutment protrusion is caused to be rotatable to abut against the second abutment protrusion.

16. The gripper according to claim 4, wherein the gripper further comprises a pallet that is removably mounted on the tail end of each clamping rod; the pallet comprises a third clamping surface disposed towards a central axis of the pivot plate and a third holding surface disposed opposite the third clamping surface; the third holding surface is attached on a plane of the clamping rod that is close to the central axis of the pivot plate; the pallet further comprises an enclosure that is arranged around an edge of the third clamping surface.

17. The gripper according to claim 4, wherein the gripper further comprises a pallet that is removably mounted on the tail end of each clamping rod; the pallet comprises a third clamping surface disposed towards a central axis of the pivot plate and a third holding surface disposed opposite the third clamping surface; the third holding surface is attached on a plane of the clamping rod that is close to the central axis of the pivot plate;
the third holding surface is arranged with a limiting catch and an assembly groove; the limiting catch and the assembly groove are distributed along an extension direction of the clamping rod; a rod body of the clamping rod is engaged with the limiting catch, and the tail end of the clamping rod is inserted into the assembly groove.

18. The gripper according to claim 4, wherein the gripper further comprises a pallet that is removably mounted on the tail end of each clamping rod; an end of the pallet comprises a second tooth that is protruding towards a central axis of the pivot plate.

19. The gripper according to claim 4, wherein a through hole is defined on a middle portion of each clamping rod, and an aperture of the through hole extends along an extension direction of the clamping rod.

20. A crane machine, comprising a bead chain, a driving device, and the gripper according to claim 4;
wherein the bead chain connects the gripper and the driving device;
the driving device is configured to cause the fixed disk and the pivot plate of the gripper to move closer to or away from each other by driving the bead chain;
in a case where the fixed disk and the pivot plate of the gripper move closer to each other, the at least two clamping rods of the gripper move closer to each other;
in a case where the fixed disk and the pivot plate of the gripper move away from each other, the at least two clamping rods of the gripper move away from each other.
